(19) United States
(12) Patent Application Publication
(10) Pub. No.: US 2018/0172567 A1
(43) Pub. Date: Jun. 21, 2018

(54) A METHOD FOR MEASURING DAMAGE PROGRESSION AND A SYSTEM FOR MEASURING DAMAGE PROGRESSION

(71) Applicant: NATIONAL INSTITUTE OF ADVANCED INDUSTRIAL SCIENCE AND TECHNOLOGY, Tokyo (JP)

(72) Inventors: Yuki FUJIO, Tosu-shi (JP); Chao-Nan XU, Tosu-shi (JP)

(73) Assignee: NATIONAL INSTITUTE OF ADVANCED INDUSTRIAL SCIENCE AND TECHNOLOGY, Tokyo (JP)

(21) Appl. No.: 15/571,102

(22) PCT Filed: Jul. 4, 2016
(86) PCT No.: PCT/JP2016/069760

§ 371 Date: Nov. 1, 2017

(30) Foreign Application Priority Data
Jul. 9, 2015 (JP) 2015-137760

(51) Int. Cl. G01N 3/10; G01N 19/08; G01N 21/70

(52) U.S. Cl. CPC G01N 3/10; G01N 21/70; G01N 19/08

(57) ABSTRACT

PROBLEM TO BE SOLVED

Under conventional methods, calculation for determining the extent of damage progression inside a structural body by computation is difficult to apply in actual practice, and also time consuming. In addition, detection of damage occurring in objects with complicated shapes or infinitesimal damage is particularly difficult.

SOLUTION

When pressure applied from one surface of an object to be measured to another surface thereof is pressurized or depressurized, the distance d1 between two distorted sections R1, R2 due to damage formed on the other surface S, is detected and the extent of the said damage progression is measured.

### TECHNICAL FIELD OF THE INVENTION

This invention relates to a method and a system for easily measuring damage progression occurring on the structural body of high pressure gas containers and the like without destroying the structure.

### BACKGROUND ART

While technologies involving hydrogen as fuel for fuel cell motor vehicles as well as fuel cell co-generation systems for households have been put to practical use, ensuring safety in the manufacture, storage and provision of hydrogen in high pressure gas equipment has become an urgent issue. It has been of particular concern that when accumulators (those existing are made of steel, aluminum carbon fiber reinforced plastic, etc.) required in hydrogen stations go through repeated cycles of depressurization during use and pressurization during filling, metal fatigue, hydrogen embrittlement and similar damage occur which impact their safety.

Methods for measuring the damage (defect) occurring inside these structures are the penetrant testing method which employs permeable measurement liquids and the acoustic emission method. In addition, several safe measurement methods have been proposed to deal with this problem affecting high pressure gas containers and the like (Patent Documents 1-4).

For example, in Patent Document 1, a method has been proposed for determining the lifespan of a material's fatigue crack using several coefficients obtained under the rising load test. In addition, in Patent Document 2, a fatigue designing method has been proposed for predicting the fatigue failure critical stress of a member of ferrite steel under a high pressure hydrogen gas environment using a calculation formula at a predetermined environmental condition.

Further, in Patent Document 3, a method has been proposed for determining the safe measurement of a gas container by inserting a probe inside the gas container and scanning the inner surface of the gas container with the use of the probe. Further still, in Patent Document 4, a method has been proposed for detecting damage (defect) existing on the inside of a container based on the emission intensity of the light radiated by a luminescent film containing light emitting particles formed on the structural surface thereof proportional to the magnitude of changes in strain energy density.

### PATENT DOCUMENTS

### [Patent Document 1] Japanese Patent Application Laid-Open No. 2012-184992

[Patent Document 2] International Publication No. WO 2009/014104

### [Patent Document 3] Japanese Patent Application Laid-Open No. 2007-163178

### [Patent Document 4] Japanese Patent Application Laid Open No. 2009-92644

### SUMMARY OF THE INVENTION

### Problem to be Solved by the Invention

However, in the penetrant testing method, it is necessary to apply a measurement liquid on the inner surface of the container. Accordingly, measurement takes time, and only open damage on the inner surface of the container can be detected. Also, under the acoustic emission method, damage is detected by employing acoustic emission (the elastic wave (vibration, sound wave) generated together with the incidence or progression of a crack in a material). In this manner, damage detection involving complicated or infinitesimal shapes is difficult.

Next, with respect to the method of Patent Document 1, the lifespan of a fatigue crack is not actually measured but merely predicted by calculation using coefficients obtained under the rising load test. Accordingly, it is difficult to apply as a safe measurement method.

Likewise, with respect to the method of Patent Document 2, there is no actual measurement of a fatigue but a formula is used to carry out the design of a fatigue on a material. Therefore, it is also difficult to apply as a safe measurement method.

Further, with respect to the method of Patent Document 3, it is necessary to insert a probe inside a gas container to carry out measurement. Thus, the need to open the gas container will entail delay in carrying out measurement.

Again, with respect to the method of Patent Document 4, while it is an excellent method considering that it offers a simple way of detecting a defect in the inner structure of the container without destroying the structure thereof, there are different levels of measurement accuracy in determining the size or dimensions of the defect based on the emission intensity of the luminescent film. In other words, since the emission intensity of the luminescent particles used in this method is susceptible to the external environment, it is difficult to obtain identical conditions to carry out measurement, and therefore, the incidence of various levels of measurement accuracy becomes problematic.

Considering the above mentioned circumstances, this invention seeks to propose a simple method of measuring the extent of damage progression on the structure of high pressure gas containers and the like without destroying the structure thereof and a measurement system for such purpose.

### Means for Solving the Problem

After continuous painstaking efforts, the inventor of this invention has discovered a simple method to address the problem of measuring the extent of damage progression occurring inside a structure without destroying the structure and a measurement system for this purpose.

The first aspect of the invention for solving the above mentioned problem relates to a method for measuring the extent of damage progression inside or on one surface of an object to be measured based on the state of the other surface thereof upon pressure applied from one surface to the other surface, wherein when the pressure applied from one surface to the other surface is pressurized or depressurized, the extent of damage progression is measured by detecting the distance between two distorted sections formed by the damage on that other surface.

Here, through his attempts to solve the above mentioned problem, the inventor has found out that when pressure is applied to an object to be measured, damage occurs on another surface of the object to be measured, wherein two portions (distorted sections) are formed at other parts while the distance between two distorted sections becomes shorter as the damage progresses. Therefore, the detection of changes in the distance between two distorted sections by the inventor of this invention led him to discover that the extent of damage progression can be measured.

Under the first aspect of the invention, since the distance between two distorted sections can be detected, the extent of damage progression can be measured.

The second aspect of the invention relates to a method for measuring the extent of damage progression according to the first aspect wherein the extent of damage progression is measured based on changes in the distance between two distorted sections.

Under the second aspect of the invention, because changes between two distorted sections can be detected, the extent of damage progression can be measured based on the amount of changes in the two distorted sections.

The third aspect of the invention relates to a method for measuring the extent of the damage progression according to first aspect or second aspect, wherein when the pressure applied from one surface to the other surface thereof is pressurized or depressurized, a luminescent film containing light emitting particles is formed on the other surface, receives strain energy and emits light with emission intensity corresponding to the magnitude of changes in strain energy density, and the distance between two distorted sections is detected upon the distribution of emission intensity of the light radiated by the luminescent film.

Under the third aspect of the invention, because the distance between two distorted sections can be detected upon the distribution of emission intensity of the light radiated by the luminescent film, the extent of damage progression can be measured easily.

The fourth aspect of the invention relates to a method for measuring the extent of damage progression according to first aspect or second aspect in which a moire fringe showing the state of the other surface is formed, and the distance between two distorted sections is detected based on the difference between the shape of the moire fringe before the pressure applied from one surface to the other surface thereof is pressurized or depressurized and the shape of the moire fringe after pressurization or depressurization.

Under the fourth aspect of the invention, because the distance between two distorted sections can be detected from the moire fringe formed, the extent of damage progression can be measured easily.

The fifth aspect of the invention provides for a system for measuring the extent of damage progression inside or on one surface of an object to be measured based on the state of the other surface thereof upon pressure applied from one surface to the other surface, wherein the system comprising: a pressure means for pressurizing or depressurizing the pressure applied from one surface to the other surface of the object to be measured; and a distorted section detecting means for detecting two distorted sections formed by damage occurring on the other surface when pressure applied from one surface to the other surface is pressurized or depressurized.

Under the fifth aspect of the invention, because the distance between two distorted sections can be detected, the extent of damage progression can be measured.

The sixth aspect of the invention provides for a system for measuring the extent of damage progression according to the fifth aspect, wherein the distorted section detecting means comprising: a luminescent film containing light emitting particles formed on the other surface, receives strain energy and emits light with emission intensity corresponding to the magnitude of changes in strain energy density; and a light detecting means for detecting two distorted sections from the emission intensity radiated from the luminescent film.

Under the sixth aspect of the invention, since the distance between two distorted sections can be detected through the emission intensity of light radiated by the luminescent film, the extent of damage progression can be easily measured.

The seventh aspect of the invention provides for a system of measuring the extent of damage progression according to fifth aspect, wherein the distorted section detecting means comprising: a moire fringe forming means for forming a moire fringe showing the state of the other surface; and a moire fringe detecting means for detecting two distorted sections from a moire fringe.

Under the seventh aspect of the invention, because the distance between two distorted sections can be detected from the moire fringe formed, the extent of damage progression can be easily measured.

### DESCRIPTION OF THE DRAWINGS

FIG. 1 is a schematic view showing an example of a distorted section formed when pressure is applied to an object to be measured.

FIG. 2 is a schematic diagram of a system for measuring the extent of damage progression according to the first embodiment of the invention.

FIG. 3 is an optical image obtained when a hydraulic pressure cycle is performed with respect to a steel accumulator of Example 1.

FIG. 4 is a distribution diagram showing the amount of distortions on an outer surface based on numerical analysis with respect to a steel accumulator of Example 1.

FIG. 5 is a diagram showing the relationship between the extent of progression of cracks and the distance between points of the largest strains based on numerical analysis with respect to a steel accumulator of Example 1.

FIG. 6 is a schematic diagram of a system for measuring damage progression according to the second embodiment of the invention.

### DETAILED DESCRIPTION OF THE INVENTION

The method for measuring the extent of damage progression related to this invention pertains to a method for measuring the extent of damage progression occurring inside or on one surface of an object to be measured by detecting the changes in distance between two distorted sections formed on the other surface of the object.

Here, the term “object to be measured” in this invention refers to a structure where pressure is applied from one surface to another surface without limitation as to any particular shape, the inside of which may be filled with gas or liquid, and may also be of planar shape such as the lid of any container. The object to be measured may also be made of metal, non-metal (including ceramics), as well as polymer (such as natural resin, synthetic resin) or the like.

In addition, the term “damage” refers to any scratch, defect, crack, fissure or the like which may have occurred in the object to be measured even at the time of its manufacture, or has occurred during its use.

Further, the term “distorted section” refers to a distorted part formed on another surface of the object to be measured which is comparatively more distorted than other distorted parts formed on that other surface when the pressure applied by one surface on another surface thereof is pressurized or depressurized.

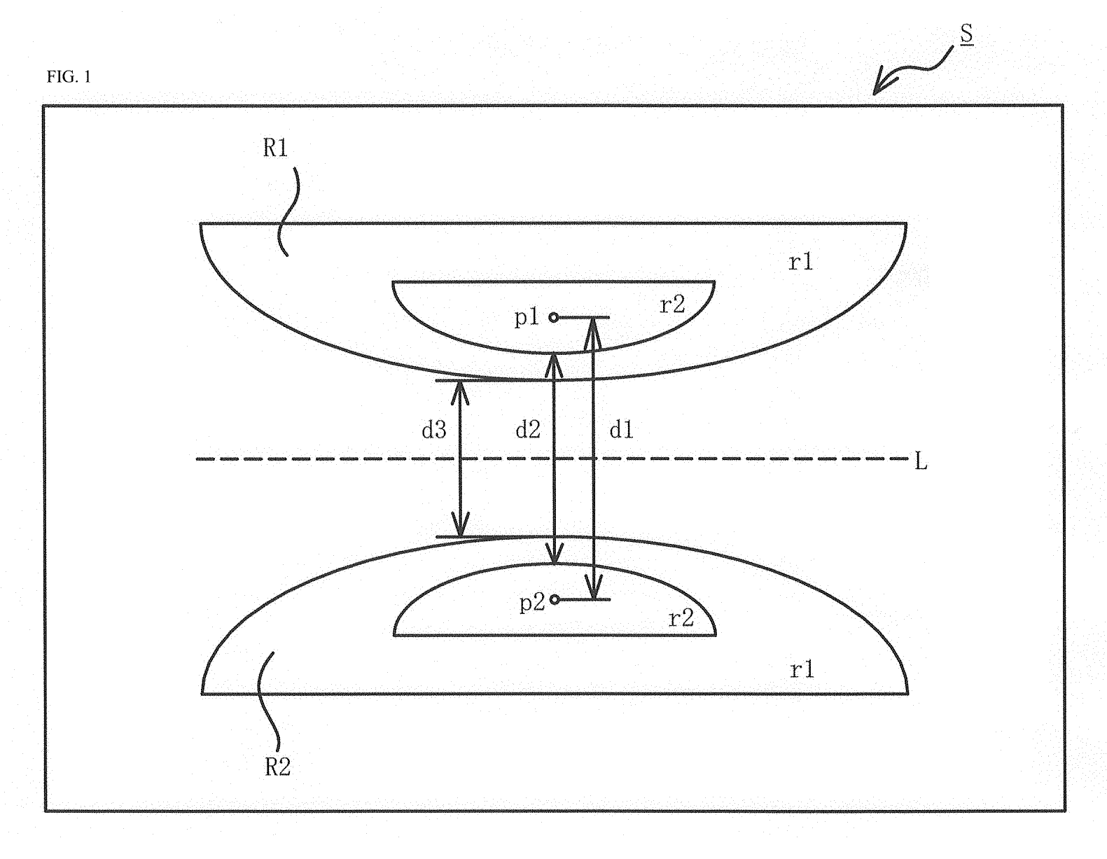

FIG. 1 shows an example of a distorted section formed on the surface of an object to be measured. As shown in FIG. 1, a distorted section comprises two parts R1, R2 symmetrically arranged in relation to the surface S of the measured object with the dotted line L as the axis of symmetry. Here, the distorted portions R1, R2 shown in this drawing are formed on the outer surface of the cylindrical object to be measured when the axial direction is in a horizontal direction as pressure is applied from the inner surface in the direction of the outer surface thereof.

Two regions r1 and r2 are formed in each of the distorted sections R1 and R2 formally divided by a predetermined amount of distortions, wherein region r2 is relatively more distorted than region r1. The most distorted parts (points) within the distorted sections R1, R2 are p1, p2. Further, the predetermined amount of distortions is within the discretion of the person conducting measurement based on the purpose of measurement.

Next, there is no particular limitation with respect to the term “distance between two distorted sections” provided that the person conducting measurement can measure the distance between two distorted sections. For example, as shown in FIG. 1, the distance d1 between the most distorted parts p1, p2 within the distorted sections R1, R2 may be considered the “distance between two distorted sections”. Also, arbitrary standard values can be assigned to distorted sections R1, R2, and the shortest distance (d2 or d3) between regions (for example between r1 or r2) exceeding the said standard values can be considered the “distance between two distorted sections”.

Here, the shape of a distorted section is not limited to the example of a distorted section described in FIG. 1. Two distorted sections may be symmetrical in shape in terms of line symmetry and point symmetry but may have completely different shapes and sizes.

Next, a method for detecting the distance between two distorted sections will be explained.

First, the state of another surface (the surface state 1) in a predetermined surface of the object to be measured is detected. Thereafter, the state of another surface (the surface state 2) at a another predetermined surface of the object to be measured at certain conditions (such as the maximum pressure/minimum pressure, the speed of increasing pressure/decreasing pressure and the like) is detected. Then, by comparing the surface state 1 and the surface state 2 through image analysis or visual observation, the two distorted sections formed on that other surface of the object to be measured can be detected. As a result, the distance between two distorted sections can be measured. Further, at this juncture, for example, using image processing technology, two distorted sections can be detected automatically and the distance between the distorted sections may be calculated.

Further, a calibration curve (standard curve) and the like based on simulated calculation or actual measurement is plotted in advance showing the relationship of damage to the distance between two distorted sections. Then, by comparing the distance between two distorted sections actually detected to the said calibration curve, the extent of damage progression can be estimated.

Also, once the distance between two distorted sections under the above mentioned conditions of detection is measured, using the same object again under certain conditions (period of use, no. of times of use and the like), the distance between two distorted sections of the same object under the same conditions of detection can be measured again.

Then, by comparing the distance between two distorted sections of the object to be measured before use and after use of the object, the amount of changes in the distance between two distorted sections can be detected. As mentioned above, since there is a relationship between the extent of damage progression and the distance between two distorted sections, the extent of progression of a crack can be estimated from the amount of changes in the distance.

A detailed description of the preferred embodiments of the invention related to a method for measuring the extent of damage progression and a system for measuring the extent of damage progression will be explained below in conjunction with the attached drawings. It should be noted that the present invention is not limited to the following embodiments.

### The First Embodiment

The first embodiment pertaining to the formation of a luminescent film containing light emitting particles on the outer surface of an object to be measured, and the detection of the distance between two distorted sections based on the distribution of emission intensity of the light radiated from the luminescent film, will be explained hereafter.

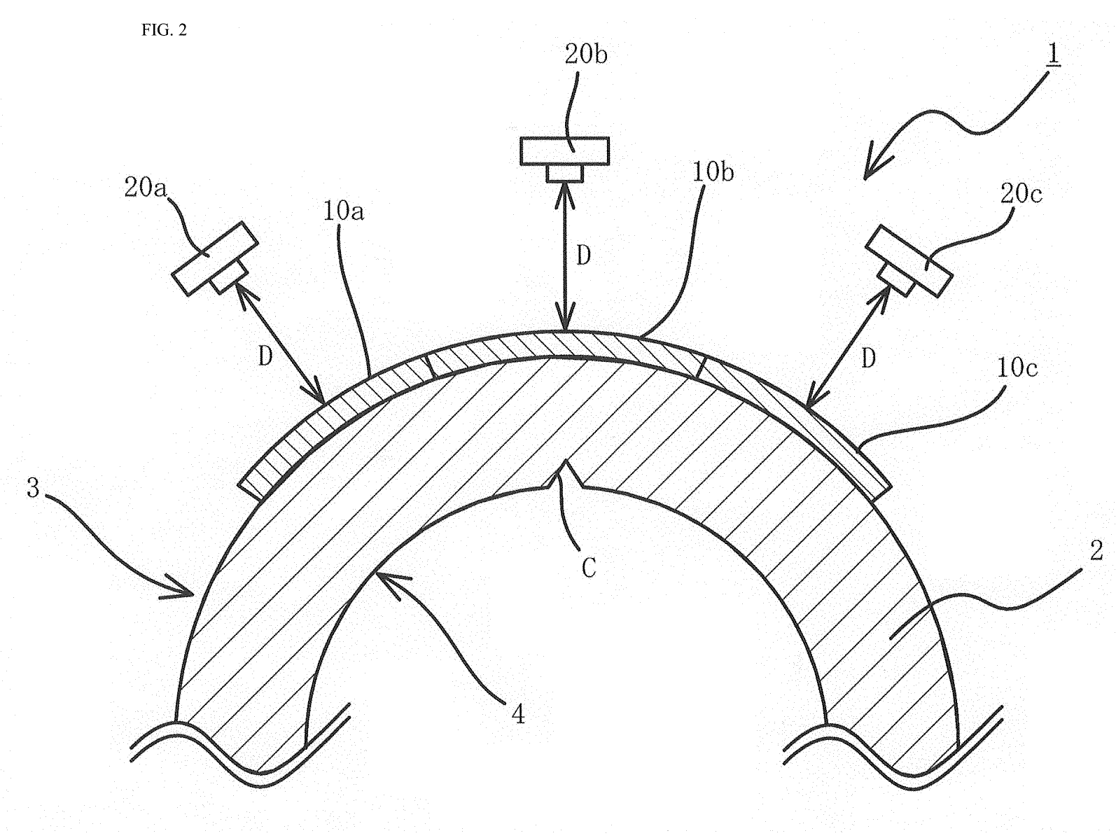

A schematic diagram of the embodiment related to a system for measuring the extent of damage progression is shown in FIG. 2. As illustrated in the said diagram, the system 1 for measuring the extent of damage progression in this embodiment comprises an object to be measured 2 comprising a container having a cylindrical shape with an outer surface 3, on which luminescent films 10a, 10b, 10c containing light emitting particles are formed. The luminescent films 10a, 10b, 10c are in close contact or adhere to the distorted section of the outer surface 3 of the object to be measured 2 and are distorted in conjunction with the said distorted section of the outer surface 3 of the object to be measured 2. Also, the luminescent films 10a, 10b, 10c receive strain energy generated on the outer surface 3 of the object to be measured 2, emit light with an emission intensity corresponding to changes in the magnitude of the strain energy density.

Next, light radiating from each of the luminescent films 10a, 10b, 10c is detected by optical cameras 20a, 20b, 20c respectively arranged as light detection means on the upper side in a vertical direction in relation to the surface of the central portion of each of the luminescent films 10a, 10b, 10c. Here, there is no particular limitation with respect to the kind of optical cameras 20a, 20b, 20c to be used for as long as they are capable of detecting light radiating from the luminescent films 10a, 10b, 10c, and even commercially available digital cameras can function as light detecting means. It should be noted that under this embodiment, the luminescent films 10a, 10b, 10c and optical cameras 20a, 20b, 20c constitute the distorted section detecting means.

The optical cameras 20a, 20b, 20c respectively corresponding to the luminescent films 10a, 10b, 10c are arranged in such manner that the distances D between the optical cameras 20a, 20b, 20c and the luminescent films 10a, 10b, 10c are equal to each other, to ensure that there would be no variations in the light emission intensity detected that may be due to differences in the said distances D. Incidentally, these optical cameras 20a, 20b, 20c may also be affixed to an object to be measured 2 or to a device other than the object to be measured 2.

On the other hand, a crack (damage) C is formed on the central portion of the inner surface 4 of the object to be measured 2, and using a pressure means such as a pump (not shown in the diagram), the pressure applied from the inner surface 4 to the outer surface 3 can be pressurized or depressurized. Thereafter, following repeated pressurization and depressurization, the crack C further develops towards the outer surface due to metal fatigue and the like. It should be noted that there is no particular limitation as to the pressure means to be used for causing changes in the pressure to be applied on the inner portion of the object to be measured 2. For example, any instrument or device that is capable of physically applying pressure to the object to be measured 2 from the inner surface 4 thereof to its outer surface 3 may be used.

Here, there is no particular limitation with respect to the luminescent films 10a, 10b, 10c for as long as they are capable of dispersing light emitting particles uniformly and can be distorted in conjunction with the distortion on the outer surface 3 of the object to be measured 2. For example, as the light emitting films 10a, 10b, 10c, resins like epoxy resin or urethane resin are uniformly mixed with a curing agent and a solvent for controlling their cross linking and curing reactions and luminescent particles are uniformly mixed with a dispersing agent and auxiliary agent for uniformly dispersing the luminescent particles, and the resulting liquid mixture may be used to coat and cure the outer surface 3 of the object to be measured 2.

There is no particular limitation with respect to the luminescent particles contained in the luminescent films 10a, 10b, 10c as long as they are capable of receiving strain energy and emit light with an emission intensity corresponding to the magnitude of changes in the strain energy density.

Examples of base material for luminescent particles are oxides, sulfides, phosphates, silicates, carbides or nitrides having a stuffed tridymite structure, three-dimensional network structure, feldspar structure, crystal structure with lattice defect control, Wurtz structure, spinel structure, corundum structure or a β-alumina structure, with rare earth ions of Sc, Y, La, Ce, Pr, Nd, Pm, Sm, Eu, Gd, Tb, Dy, Ho, Er, Tm, Yb, and Lu, as well as transition metal ions of Ti, Zr, V, Cr, Mn, Fe, Co, Ni, Cu, Zn, Nb, Mo, Ta and W as luminescent center.

Among these luminescent particles, when strontium and an aluminum-containing composite oxide, for example, are used as base material, light emitting particles using xSrO.yAl₂O₃.zMO or xSrO.yAl₂O₃.zSiO₂ are desirable (where M is a divalent metal, and although not restricted to M, Mg, Ca, Ba are preferable, and x, y and z are integers of 1 or more). However, light emitting particles using SrMgAl₁₀O₁₇:Eu, (SrₓBa^{1-x})Al₂O₄: Eu (0<x<1), BaAl₂SiO₈: Eu are preferable. Then, in this embodiment, the luminescent particles have an α-SrAl₂O₄ structure, and Eu as the luminescent center is most desirable.

In addition, in order to increase the luminescence sensitivity to strain, it would be desirable to add a substance that generates lattice defects during production of the luminescent particles, and Ho is particularly preferable. By adding such a lattice defect generating substance, luminescence sensitivity to large strain energy can be improved. It should be noted that the preferable average diameter of luminescent articles (measured by laser diffraction method) would be 20 μm or less, and more preferably, 10 μm or less.

Although not shown in the diagram, the system 1 for measuring the extent of damage progression according to the present embodiment provides for an information processing unit for storing data from the optical cameras 20a, 20b, and 20c and image processing using such data, such that the distance between a distorted section and two distorted sections is automatically calculated. The above mentioned processes can be performed by an information processing unit such as a personal computer and the like.

The availability of such an information processing unit makes the measurement of the distance between two distorted sections more convenient. As a result, the extent of progression of the crack C formed on the internal surface 4 of the object to be measured 1 can be easily measured.

Still, under this embodiment, although the luminescent films 10a, 10b, 10c are formed only on a part of the outer surface 3 of the object to be measured 2, there is no limitation to the size of the luminescent films, such that for example, the luminescent film may be formed on the entire outer surface 3 of the object to be measured 2.

### Example 1

The system for measuring the extent of damage progression under the first embodiment is specifically constructed in the following manner. The object to be measured is a steel accumulator made of Cr—Mo steel (JIS standard: SCM 435) with a length of 300 mm, an outer diameter of 270 mm, an inner diameter of 210 mm (and thickness of 30 mm). SrAl₂O₄:Eu with an average particle diameter of 1 μm and epoxy resin were mixed at a weight ratio of 50:50, to which a curing agent (EPICLON B-570-H made by DIC Corporation) was added for hardening, to form a luminescent film with a thickness of about 60 μm on the outer surface of the steel accumulator. Further, a crack with a length of 72 mm, a width of 0.5 mm, and a depth of 24 mm was formed parallel to the inner surface of this steel accumulator in an axial direction.

Thereafter, using a hydraulic pump and the like, water pressure cycle tests were conducted in this steel accumulator at 0.1 to 45 MPa (each cycle lasting 16 seconds) and emission of light was detected from the luminescent films.

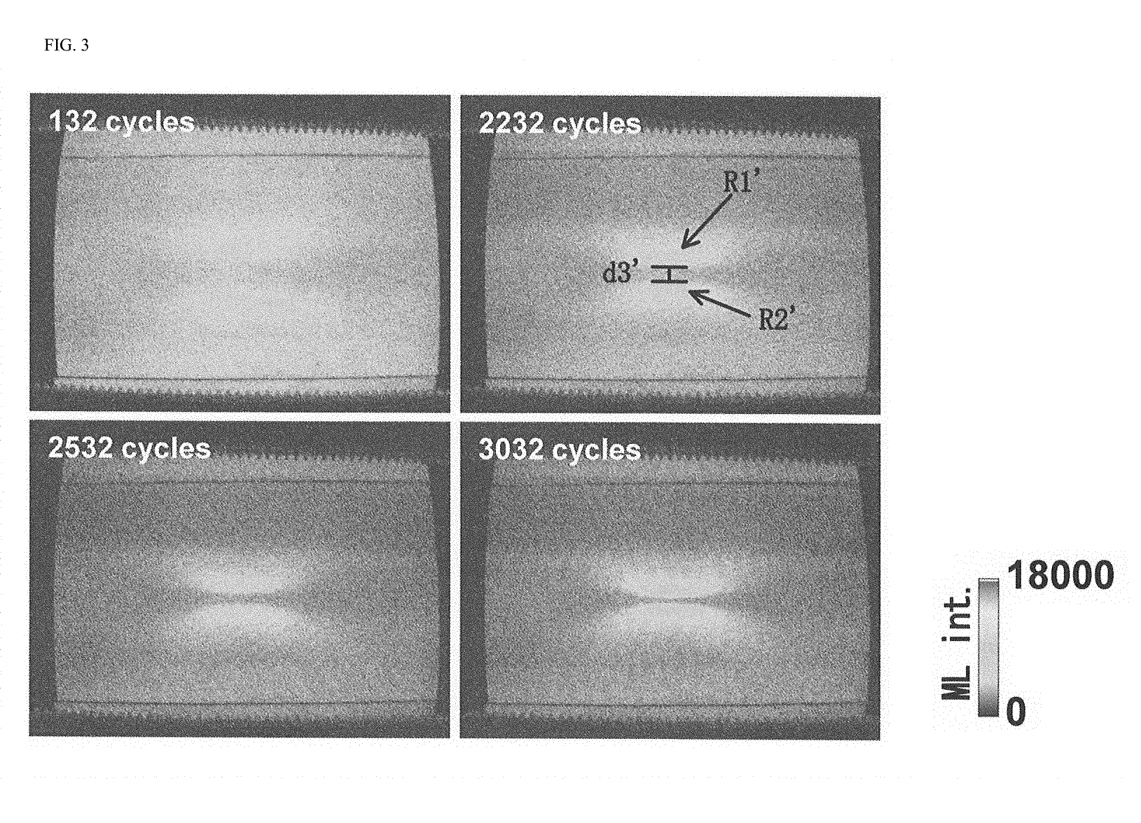

This result is illustrated in FIG. 3. It should be noted that the number of cycles is shown on the upper right side while the increasing emission intensity is illustrated in accordance with the index from blue to red indicated on the lower right side of each cycle diagram.

FIG. 3 shows the detection of two distorted sections R1′, R2′ as observed. Thereafter, it can be seen that as the number of water pressure cycles increases, the distance between the distorted sections R1′, R2″ becomes smaller.

Next, in order to clarify the relationship between the crack and the distance between the two distorted sections R1′, R2′, a numerical analysis of the amount of distortions generated on the outer surface of the steel accumulator is conducted in relation to the above described system for measuring the extent of damage progression using ANSYS (trademark) made by ANSYS Inc.

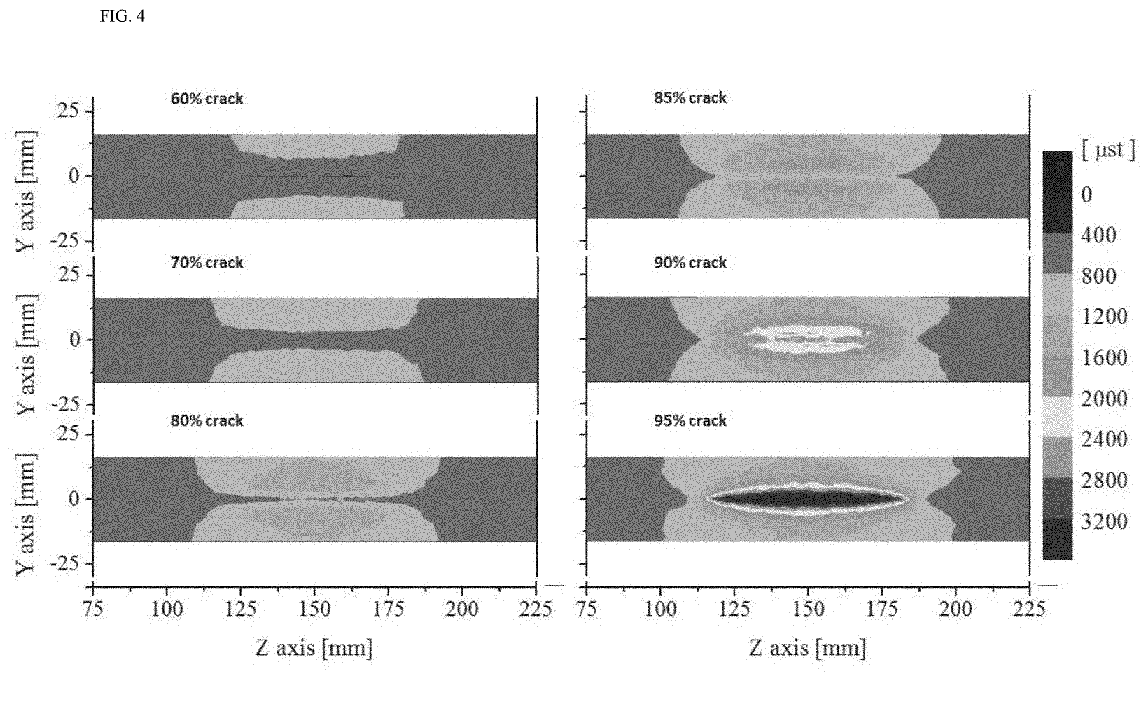

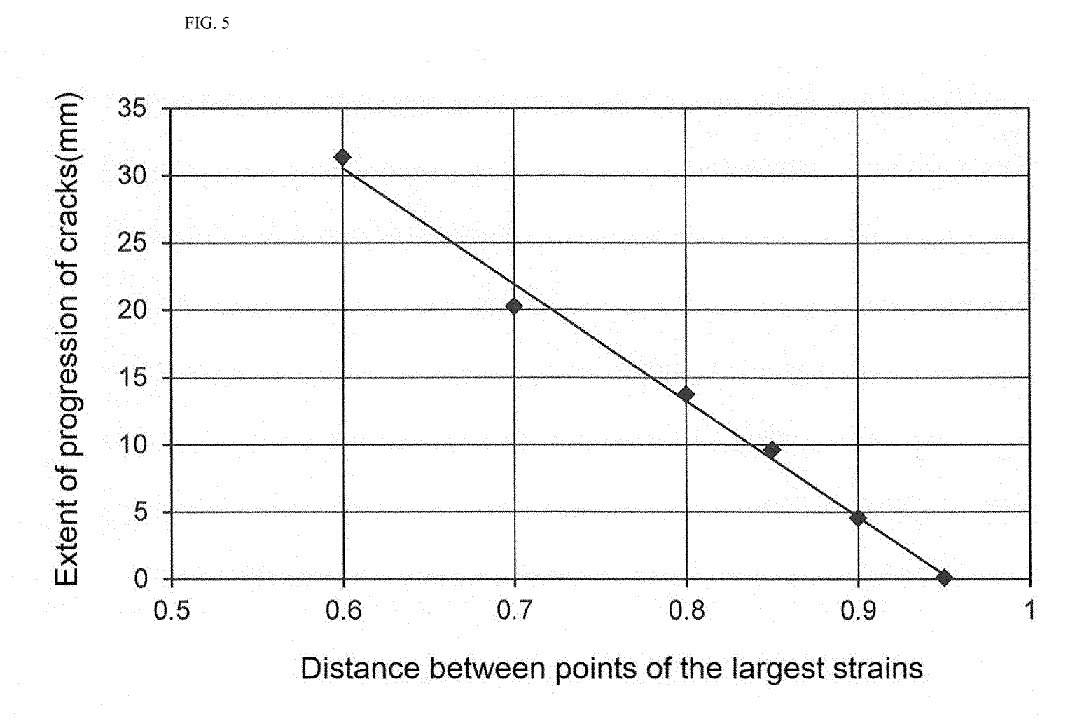

The results are shown in FIGS. 4 and 5. In FIG. 4, the upper portion of each chart shows the rate of a crack in relation to the thickness of the steel accumulator. For example, 60% crack indicates the calculated result in case a crack having a length of 18 mm corresponding to 60% of the thickness (30 mm) of the steel accumulator is formed in the thickness direction thereof.

As can be seen from these charts, the distance between the two distorted sections becomes smaller as the crack develops.

From the above, the extent of crack (damage) progression can be measured by measuring the distance between two distorted portions on the outer surface of the steel accumulator.

It should be noted that as mentioned above, in Example 1, although the extent of crack progression was measured by measuring the distance between two distorted sections, the relationship between the extent of crack progression and the distance between two distorted sections may be unclear. In such event, the amount of changes in crack progression may be estimated based on the amount of changes detected in the distance between two distorted sections.

### The Second Embodiment

In the first embodiment, luminescent films are formed on the outer surface of the object to be measured, and while the distance between two distorted sections can be detected from the distribution of emission intensity of the light radiated from the luminescent films, a moire fringe may be formed on the outer surface showing the state thereof, and the distance between two distorted sections may be detected based on changes in the moire fringe when pressure from the inner surface to the outer surface of the object to be measured is pressurized or depressurized.

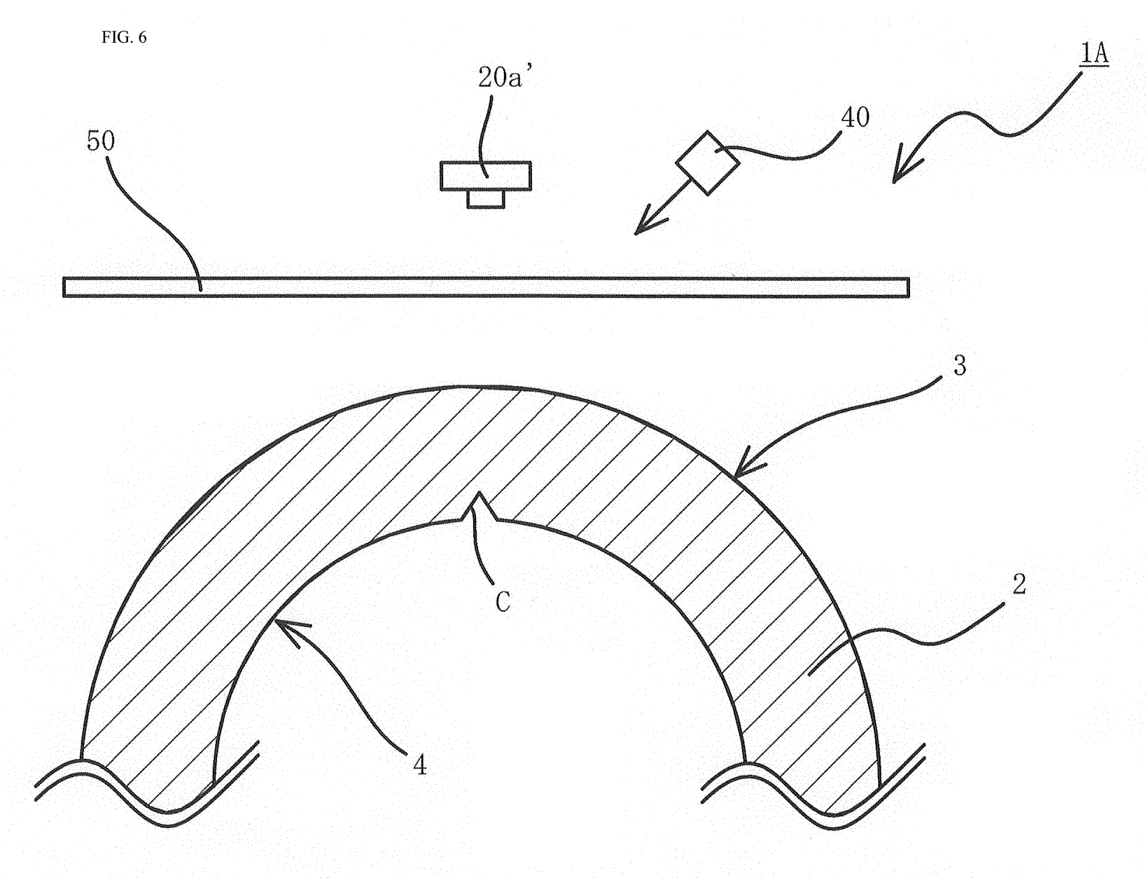

FIG. 6 is a schematic diagram of the system 1A for measuring the extent of damage progression in relation to the present embodiment. As shown in FIG. 6, a grid plate 50 is arranged above the object to be measured 2 to generate moire interference. A light source 40 is disposed above the right side of the grid plate 50 in order that the outer surface 3 of the object to be measured 2 can be radiated with light through the grid plate 50. The light source 40 is not subject to any limitation and may be any kind of light, such as for example, commercially available white light, for as long as it is capable of radiating light. In addition, in this embodiment, the grid plate 50 and light source 40 constitute the moire fringe forming means.

In addition, as a moire fringe detecting means, an optical camera 20a′ is arranged directly above the grid plate 50 for detecting moire fringes on the outer surface 3 of the object to be measured 2. The grid plate 50 is not subject to any limitation provided that it comprises a plate capable of generating moire interference. Likewise, there is no limitation with respect to the size and shape of the plate. Further, the optical camera 20a′ is not subject to any limitation and may be any kind of camera, such as for example, commercially available digital cameras, provided the same is capable of detecting moire fringes.

Then, as above-described, in this system 1A for measuring the extent of damage progression, a pump and the like is utilized as pressure means (not shown in the drawing) for pressurizing or depressurizing pressure applied from the inner surface 4 to the outer surface 3 and moire fringes formed on the outer surface are detected through the optical camera 20a′. In the moire fringes that have been detected, two distorted sections similar to the detected result obtained pursuant to the system 1 for measuring the extent of damage progression in embodiment 1 likewise appeared. This being the case, the distance between two distorted sections and changes in such distance can be detected. Accordingly, it becomes possible to measure the extent of damage progression occurring on the inside or one surface of an object to be measured.

Still, while the system 1A for measuring the extent of damage progression is constituted in this second embodiment of the invention as described above, provided that the moire fringes formed can show the state of the outer surface 3 of the object to be measured 2, there is no particular limitation with respect to the moire fringes. A system for measuring the extent of damage progression comprising another moire method (moire topography) for detecting moire fringes may also be configured. For example, in addition to the moire method of the grating irradiation type in this embodiment, the grid projection type is another moire method which may be used for detecting moire fringes. Even if a system for measuring the extent of damage progression is configured in this manner, similar results can be obtained.

### Another Embodiment

In the method for measuring the extent of damage progression and the system for measuring the extent of damage progress related to this invention, the method for detecting the distance between two distortion sections and the configuration of the distortion section detecting means is not particularly limited to such method and configuration as described above, provided that the state of the outer surface of the object to be measured can be detected. For example, image analysis (image analysis device) such as the stereo imaging method using the stereo matching method, or the light section method which is an expansion of the surface triangulation principle and the like, may be employed, wherein the distance between two distorted sections and amount of changes thereof can be detected.

Even using image analysis as above mentioned makes the measurement of the extent of progression of damage occurring on the inside or on one surface of an object to be measured possible.

### IDENTIFICATION OF SYMBOLS

1,1A System for measuring the extent of damage progression
3 Outer surface of the object to be measured
4 Inner surface of the object to be measured
10 a, 10 b, 10 c Luminescent films
20a, 20a′, 20b, 20c Optical cameras
40 Light source
50 Grid plate
C Crack
R1, R1′, R2, R2′ Distorted sections

1. A method for measuring the extent of damage progression inside or on one surface of an object to be measured based on the state of the other surface thereof upon pressure applied from one surface to the other surface thereof,
wherein when the pressure applied from one surface to the other surface is pressurized or depressurized, the extent of damage progression is measured by detecting the distance between two distorted sections formed by the damage on that other surface.

2. A method for measuring the extent of damage progression according to claim h wherein the extent of damage progression is measured based on changes in the distance between two distorted sections.

3. A method for measuring the extent of the damage progression according to claim 1, wherein when the pressure applied from one surface to the other surface thereof is pressurized or depressurized, a luminescent film containing light emitting particles is formed on the other surface, receives strain energy and emits light with emission intensity corresponding to the magnitude of changes in strain energy density, and the distance between two distorted sections is detected upon the distribution of emission intensity of the light radiated by the luminescent film.

4. A method for measuring the extent of the damage progression according to claim 2, wherein when the pressure applied from one surface to the other surface thereof is pressurized or depressurized, a luminescent film containing light emitting particles is formed on the other surface, receives strain energy and emits light with emission intensity corresponding to the magnitude of changes in strain energy density, and the distance between two distorted sections is detected upon the distribution of emission intensity of the light radiated by the luminescent film.

5. A method for measuring the extent of damage progression according to claim 1 in which a moire fringe showing the state of the other surface is formed, and the distance between two distorted sections is detected based on the difference between the shape of the moire fringe before the pressure applied from one surface to the other surface thereof is pressurized or depressurized and the shape of the moire fringe after pressurization or depressurization.

6. A method for measuring the extent of damage progression according to claim 2 in which a moire fringe showing the state of the other surface is formed, and the distance between two distorted sections is detected based on the difference between the shape of the moire fringe before the pressure applied from one surface to the other surface thereof is pressurized or depressurized and the shape of the moire fringe after pressurization or depressurization.

7. A system for measuring the extent of damage progression inside or on one surface of an object to be measured based on the state of the other surface to which pressure is applied from one surface to the other surface, wherein the system comprising:
a pressure means for pressurizing or depressurizing the pressure applied from one surface to the other surface of the object to be measured; and
a distorted section detecting means for detecting two distorted sections formed by damage occurring on the other surface when pressure applied from one surface to the other surface is pressurized or depressurized.

8. A system for measuring the extent of damage progression according to claim 7, wherein the distorted section detecting means comprising:
a luminescent film containing light emitting particles formed on the other surface, receives strain energy and emits light with emission intensity corresponding to the magnitude of changes in strain energy density; and
a light detecting means for detecting two distorted sections from the emission intensity radiated from the luminescent film.

9. A system of measuring the extent of damage progression according to claim 7, wherein the distorted section detecting means comprising:
a moire fringe forming means for forming a moire fringe showing the state of the other surface; and
a moire fringe detecting means for detecting two distorted sections from a moire fringe.
